(19) United States
(12) Patent Application Publication
(10) Pub. No.: US 2013/0103283 A1
(43) Pub. Date: Apr. 25, 2013

(54) DIGITAL FILTER FOR AN EVENT DRIVEN ENGINE CONTROLLER HAVING A VARIABLE SAMPLE RATE

(71) Applicant: GERARD W. MALACZYNSKI, BLOOMFIELD HILLS, MI (US)

(72) Inventor: GERARD W. MALACZYNSKI, BLOOMFIELD HILLS, MI (US)

(73) Assignee: DELPHI TECHNOLOGIES, INC., Troy, MI (US)

(21) Appl. No.: 13/276,349

(22) Filed: Oct. 19, 2011

(51) Int. Cl. G01M 15/08; G01M 15/06; G01M 15/00

(52) U.S. Cl. 701/99

(57) ABSTRACT

A method of implementing a digital filter in an event driven engine controller configured to sample an analog signal at a sample rate dependent on a time interval between engine events such as the time interval between pulses from a crank sensor signal. Since the sample rate is variable, the filter coefficients in the digital filter need to be adjusted or updated in response to changes in the sample so that the filter characteristic or transfer function remains consistent even though the sample rate varies.

### STATEMENT REGARDING GOVERNMENT SPONSORED DEVELOPMENT

This invention was made with United States Government support under Government Contract/Purchase Order Number SUB-DE-EE0003347-2 awarded by the Department of Energy. The Government has certain rights in this invention.

### TECHNICAL FIELD OF INVENTION

This disclosure generally relates to digital filters, and more particularly relates to a way to implement a digital filter in an event driven engine controller where a sample rate of a signal to the digital filter is dependent on a time interval between events.

### BACKGROUND OF INVENTION

Digitally filtering a series of digital data corresponding to an analog signal sampled at a predetermined sampling frequency is known. An advantage of digital filters is that filter characteristics such as cut-off frequency and gain are readily changed by changing one or more filter coefficients used by the digital filter.

Most engine controllers used to control operation of an internal combustion engine are ‘event driven’ type engine controllers. In general, event driven engine controllers initiate execution of program steps in response to an event signal as opposed to initiating program steps in accordance with a timing signal. The event signal may be, for example, an engine crank signal formed of a series of pulses, where each pulse is temporally separated from a subsequent pulse by a variable time period or variable event period. As the event driven engine controller receives the engine crank signal and determines an engine crank position based on the engine crank signal, the controller may respond by outputting a fuel injection signal, a spark ignition signal, or an analog to digital (A/D) trigger or gate signal that initiates taking a sample of an analog signal and converting that sample into a sampled signal value.

It has been discovered that it is convenient for an analog signal received by event driven engine controller to be sampled according to an engine parameter such as crank position or the like. For example, it may be desirable to sample an analog signal every 0.1 degrees of crank rotation. Unfortunately, because of the wide range of engine operating speeds, 600 RPM to 6000 RPM for example, the sampling rate may vary greatly. In general, filter coefficients suitable for filtering a signal sampled at a relatively low rate corresponding to a low engine speed would not be suitable for filtering a signal sampled at a relatively high rate corresponding to at a high engine speed. As such, event driven engine controllers are typically equipped with analog filters. However, analog filters are undesirable because they require electrical component value and configuration changes to change the filter characteristics of the analog filter to adapt the engine controller to a variety of engines.

### SUMMARY OF THE INVENTION

In accordance with one embodiment, a method of implementing a digital filter in an event driven engine controller configured to sample an analog signal at a sample rate dependent on a time interval between engine events is provided. The method includes the step of selecting a desired filter characteristic to filter a sampled signal arising from sampling the analog signal. The method includes the step of determining an event period corresponding to a time interval between a first engine event and a second engine event indicated by an engine event signal. The method includes the step of synthesizing a gate signal to establish a sample rate based on the event period. The method includes the step of determining a filter coefficient based on the sample rate and the desired filter characteristic. The method includes the step of sampling the analog signal at the sample rate to generate the sampled signal; and digital filtering the sampled signal using the filter coefficient.

In another embodiment, an event driven engine controller is provided. The controller includes a processor. The processor is configured to store a desired filter characteristic to filter a sampled signal arising from sampling the analog signal, determine an event period corresponding to a time interval between a first engine event and a second engine event indicated by an engine event signal synthesize a gate signal to establish a sample rate based on the event period, determine a filter coefficient based on the sample rate and the desired filter characteristic, sample the analog signal at the sample rate to generate the sampled signal, and digitally filter the sampled signal using the filter coefficient.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of an engine control system in accordance with one embodiment;

FIG. 2 is a diagram of a second order band-pass Butterworth digital filter used by the system of FIG. 1 in accordance with one embodiment;

FIG. 3 is a graph of filter coefficients versus engine speed used by the filter of FIG. 2 in accordance with one embodiment; and

FIG. 4 is a flowchart of a method of operating the system of FIG. 1 in accordance with one embodiment.

### DETAILED DESCRIPTION

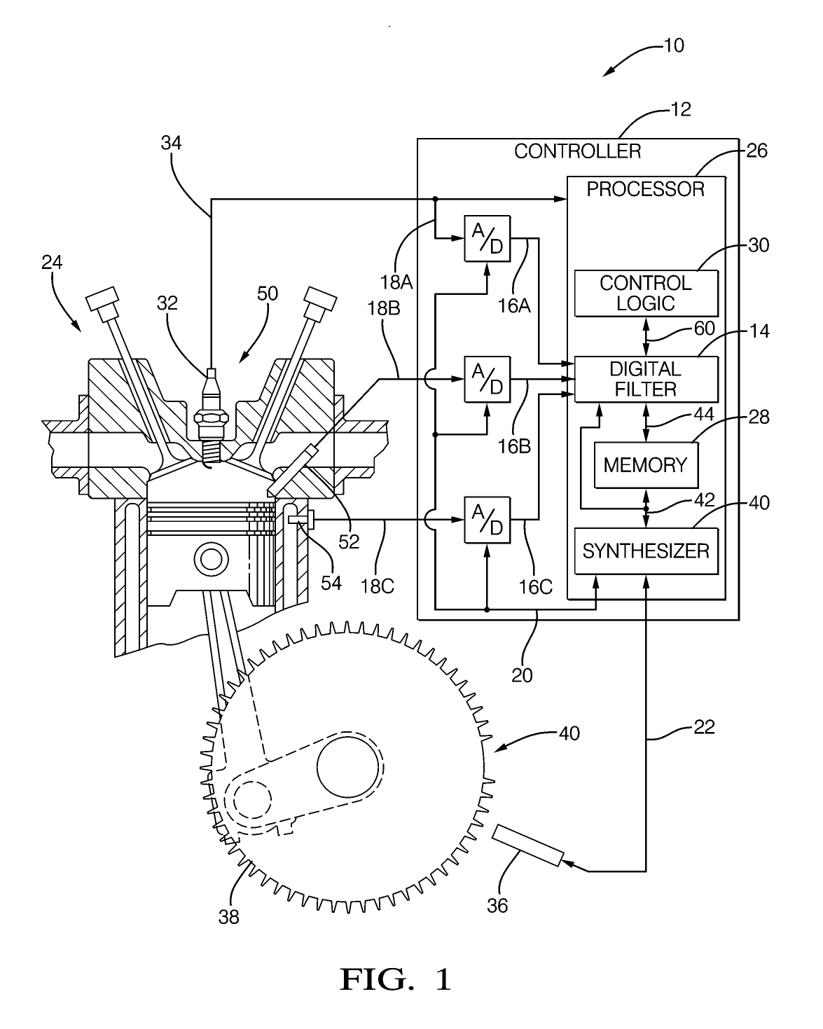

FIG. 1 illustrates a non-limiting example of an engine control system 10 that includes a non-limiting example of an event driven engine controller 12. In general, the description and examples set forth herein describe a way to provide a digital filter 14 for the event driven engine controller 12 that processes a sampled signal (16A, 16B, 16C) of an analog signal (18A, 18B, 18C) sampled in response to a gate signal 20 that may be characterized as having a variable sample rate. As used herein, an event driven engine controller 12 is a type of controller that, in contrast to a timer based controller that initiates execution of program steps in response to timing derived from a fixed frequency reference signal such as a clock signal, the event driven engine controller initiates execution of program steps in response to an engine event signal 22. An engine event signal is, in general, not based on a fixed frequency reference signal, but is based on the occurrence of some event whose timing is dependent on the rotational speed at which an engine 24 is operating.

It has been suggested that an event driven engine controller 12 may preferably be configured to sample an analog signal 18A, 18B, 18C at a sample rate dependent on a time interval between events. The analog signal 18A, 18B, 18C may be indicative of an engine combustion process. For example, the analog signal 18A may be from an in-cylinder flame sensor 50 such as an ion-sense type spark plug and so be an indication of a flame within a combustion chamber of an engine; or the analog signal 18B may be from an in-cylinder pressure sensor 52 and so be indicative of pressure within a combustion chamber of an engine; or the analog signal 18C may be from a knock sensor 54 and so be indicative of acoustic noise, e.g. spark knock, within a combustion chamber of an engine. However, the digital filter 14 may have a filter characteristic or transfer function that is defined by filter coefficients that are sample rate dependent, and so it is recognized that the filter characteristics of a digital filter 14 will change if the sample rate varies. As such, as will be described in more detail below, it may be necessary for an event driven engine controller 12 to adjust the filter coefficient(s) used by the digital filter 14 in accordance with the sample rate indicated by the gate signal 20.

The controller 12 may include a processor 26 such as a microprocessor or other control circuitry as should be evident to those in the art. The controller 12 may include memory 28, such as electrically erasable programmable read-only memory (EEPROM) for storing one or more routines, thresholds, captured data, or filter coefficients. The one or more routines may be executed by control logic 30 to perform steps for determining if signals received by the controller 12 require an action for operating the engine 24, such as outputting an ignition signal 34 to a spark plug 32, or an injection signal to a fuel injector (not shown).

Continuing to refer to the non-limiting example presented in FIG. 1, the processor 26 may be configured to store a desired filter characteristic that characterizes the digital filter 14 used to filter the sampled signal 16A, 16B, 16C arising from sampling the analog signal 18A, 18B, 18C. The desired filter characteristic may include a cut-off frequency, a gain, a pass-band bandwidth, or other characteristic known to those skilled in the art to characterize a filtering effect of the digital filter 14. The desired filter characteristics may be stored by storing filter coefficients in the memory 28 that are used by the digital filter 14. selecting a The desired filter characteristic may be then selected and/or retrieved from memory in preparation to filter a sampled signal 16A, 16B, 16C arising from sampling the analog signal 18A, 18B, 18C when the controller 12 is installed in a particular vehicle (not shown) and coupled to a particular engine such as the engine 24.

The engine control system may be equipped with a crank sensor 36 configured to detect rotation of a 58-tooth crank wheel 38. In this non-limiting example, the teeth of the wheel 38 are spaced at about 6.0 degree intervals about the wheel 38, except for the missing tooth section 44. As the wheel 38 rotates, the teeth of the wheel 38 pass by the crank sensor 36 that generates the engine event signal 22. In this example, the engine event signal 22 may be a series of pulses where a time interval between various pulses corresponds to the rotational speed of the wheel 38 and so indicates an operating speed of the engine 24. The operating speed is typically expressed in terms of revolutions per minute (RPM). The processor 26 may include a synthesizer 40 configured to determine a time interval between various pulses, and so the synthesizer 40 may be characterized as being configured to determine an event period corresponding to a time interval between a first engine event, e.g. a particular tooth of the wheel 38 passing the crank sensor 36, and a second engine event, e.g. another particular tooth of the wheel 38 passing the crank sensor 36, as indicated by the engine event signal 22. The missing tooth section 44 provides an indication of a reference position of the wheel 38, and so the event signal may also be indicative of a particular crank position. The process or algorithm used to determine crank position from an engine event signal 22 based on rotation of a 58-tooth crank wheel 38 with a missing tooth section 44 is known to those skilled in the art of engine control.

It may be desirable to estimate the position of the wheel 38 with a degree of resolution that is greater or finer than the 6.0 degree resolution inherently available from a 58-tooth wheel. For example, it has been suggested that it may be advantageous to determine the position of the wheel 38 with a resolution 0.1 degrees. However as the equipment necessary to directly determine the position of the wheel 38 with such resolution is typically laboratory grade type equipment, and so is typically unacceptably costly to consider for installation into a vehicle for sale to the general public. As such, the synthesizer 40 may be configured to synthesize the gate signal 20 based on the event period from the engine event signal 22 in order to have a resolution that is finer than the engine event signal 22. For example, the event period may be a time interval that corresponds to 6.0 degrees of rotation by wheel 38. The synthesizer 40 may be configured to generate the gate signal 20 to establish a sample rate that corresponds to 0.1 degrees of rotation by wheel 38 by synthesizing a signal that oscillates about 60 times during the time interval indicated by the event period. As such, the sample rate may be characterized as being proportional to the event period. Further explanation of this synthesizing process is described in a paper by Karl Schten et al., published by the Society of Automotive Engineers (SAE) in 2007, Publication number SAE-2007-01-0774, the entire contents of which are hereby incorporated herein by reference.

The synthesizer 40 may also be configured to output a RPM signal 42 that may be used to determine an appropriate filter coefficient from a list of filter coefficients stored in the memory 28 for use by the digital filter 14. When the A/D's illustrated in FIG. 1 sample one or more of the analog signals 18A, 18B, 18C at the sample rate established by the gate signal 20 to produce the sampled signals 16A, 16B, 16C, and the digital filter 14 uses a filter coefficient that corresponds to the sample rate or RPM of the engine 24 to digitally filter the sampled signals 16A, 16B, 16C, the filter characteristic of the digital filter 14 can be consistent or unchanged or unaffected by changes in the filter sample rate.

By synthesizing a gate signal 20 to establish a sample rate that, in accordance with the non-limiting example above, is 60 times that of the engine event rate indicated by the engine event signal 22, there may be an assumption that the engine speed is relatively constant over the time interval between a first and second engine event, e.g. between subsequent pulses output by the crank sensor from adjacent teeth on the wheel 38. As such, system 10, or controller 12, or processor 26 may be configured to continue to digitally filter using the filter coefficient selected until a third engine event is detected, such as when another pulse from the crank sensor 36 is detected subsequent to the previous two pulses used to select the sample rate and filter coefficient. When the third event is detected, the processor 26 may then determine an updated event period corresponding to an updated time interval between the second engine event and a third engine event indicated by the engine event signal; synthesize the gate signal to establish an updated sample rate based on the updated event period; determine an updated filter coefficient based on the updated sample rate and the desired filter characteristic; sample the analog signal at the updated sample rate to generate the sampled signal; and digitally filter the sampled signal using the updated filter coefficient. This process of detecting another engine event and updating the sample rate and filter coefficient may continue indefinitely, or may only continue until, for example, the analog signal 18A, 18B, 18C is no longer relevant to controlling the engine 24, or a crank position is determined where the analog signal 18A, 18B, 18C is expected to be no longer relevant to controlling the engine 24.

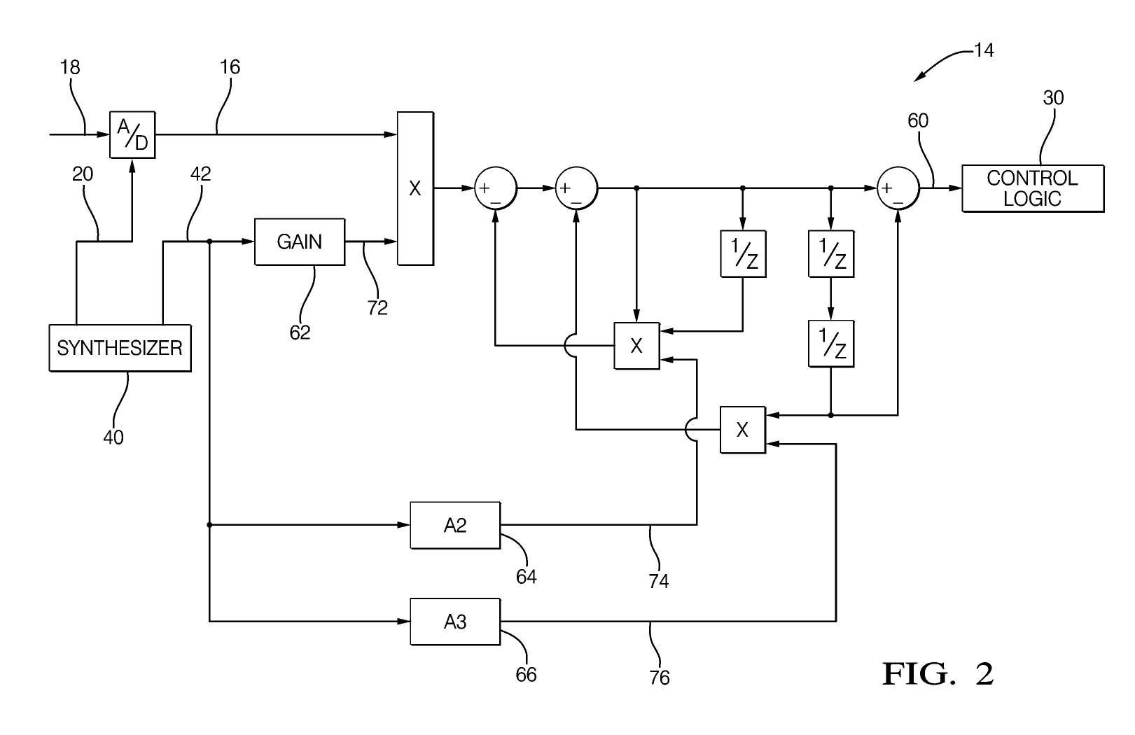

FIG. 2 illustrates a non-limiting example of digital filter 14, in particular a second order band-pass Butterworth filter where the transfer function or filter characteristics are dependent on the RPM signal 42, illustrated in a format commonly used to model or simulate the operation of a digital filter design. This example may be useful to provide a filter output signal 60 that may indicate the presence of spark knock based on an analog signal 18, for example, either the in-cylinder pressure signal 18B, or the ionization signal 18A. Engine knock typically has a characteristic frequency that depends on the size of the combustion chamber, and is typically in a range of 5 kHz to 12 kHz. The characteristic frequency may be determined based on the cylinder's dimensions or measured experimentally. For the purpose of explanation and not limitation, assume that the characteristic frequency is 7 kHz which suggests that the digital filter 14 should have a filter characteristic of a band-pass filter with a 7 kHz center frequency.

If the engine 24 was operating at a relatively low speed of 600 RPM, then simply using the engine event signal 22 from the crank sensor 36 to directly determine a gate signal would result in a sampling rate corresponding to 600 Hz (10 revolutions per second times 60 crank sensor pulses per revolution). It will be recognized that such a sampling rate is less than the minimum Nyquist sampling frequency of 14 kHz necessary for the 7 kHz. As such, the advantage of synthesizing a gate signal corresponding to 0.1 degrees of crank angle resolution instead of 6 degrees of crank angle resolution increases the sampling rate to a value corresponding to 36 kHz at 600 RPM, a value sufficient for operation of 7 kHz digital band-pass filter. However, if the engine 24 is operating a relatively high speed of 6000 RPM, the sampling rate corresponds to a frequency of 360 kHz. Those skilled in the art of digital filters will instantly recognize that the filter characteristic of the digital filter 14 using filter coefficients that provides a 7 kHz band pass filter with a sample frequency of 36 kHz will not be the same filter characteristic if the sample frequency is increased to 360 kHz, but the filter coefficient are held constant.

Continuing to refer to FIG. 2, box 62 represents a gain coefficient selector that outputs a gain coefficient 72 is determined or selected based on the RPM signal 42. Likewise, box 64 and box 66 determine or select coefficients A2 and A3, respectively, based in the RPM signal 42, and the boxes output a single delay coefficient 74 and a double delay coefficient 76, respectively. The determination or selection of the gain, A2, and A3 coefficients may be by way of a look-up table stored in the memory 28, or by way of an equation stored in the memory 28.

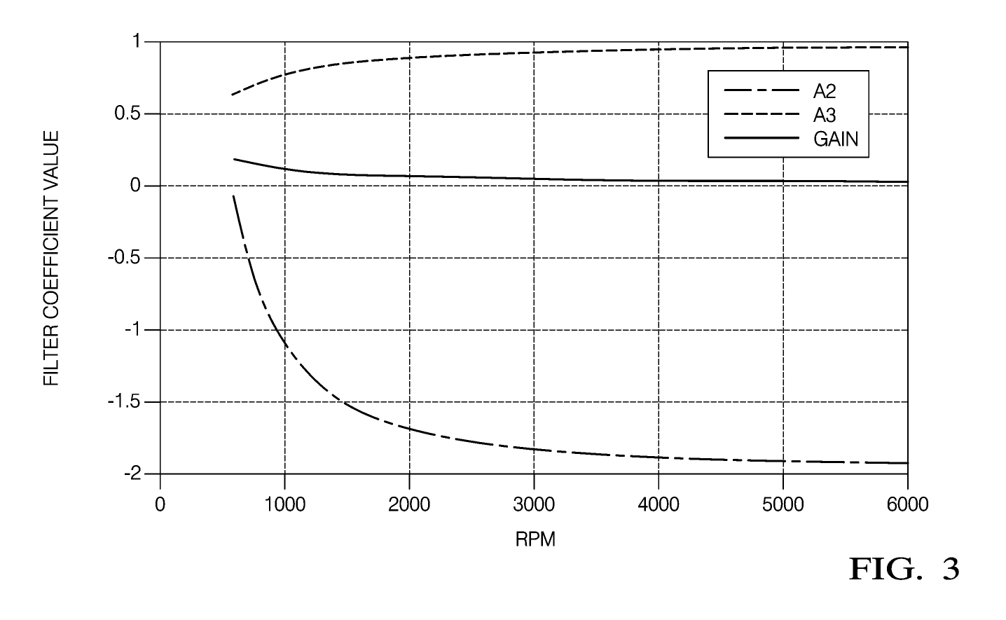

FIG. 3 illustrates a graph showing values of the gain, A2, and A3 coefficients over a range of values corresponding to the RPM signal. As suggested above, this graph could be converted into look-up tables or equations for storage in the memory 28.

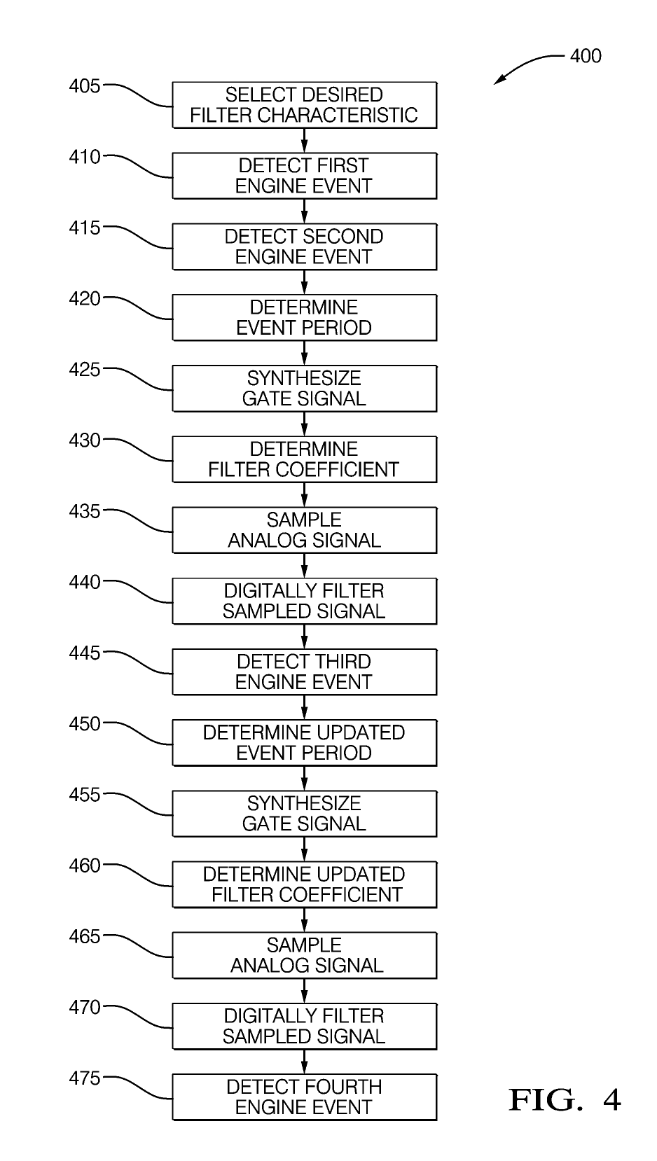

FIG. 4 illustrates a method 400 of implementing a digital filter 14 in an event driven engine controller 12 configured to sample an analog signal 18 at a sample rate dependent on a time interval between engine events indicated by an engine event signal 22. The digital filter 14 may have a filter characteristic or transfer function that is defined by filter coefficients that are sample rate dependent.

Step 405, SELECT DESIRED FILTER CHARACTERISTIC, may include selecting a desired filter characteristic to filter a sampled signal arising from sampling the analog signal based on the particular engine or class of engine being controlled, and/or the particular type of sensor being used to provide one or more of the analog signals 18A, 18B, 18C.

Step 410, DETECT FIRST ENGINE EVENT, may include detecting a pulse output by the crank sensor 36.

Step 415, DETECT SECOND ENGINE EVENT, may include detecting a subsequent pulse output by the crank sensor 36. It should be recognized that the first engine event and the second engine event may correspond to a distinct crank position.

Step 420, DETERMINE EVENT PERIOD, may include determining an event period corresponding to a time interval between a first engine event and a second engine event indicated by an engine event signal. Determining an event period may be by way of the synthesizer timing the time interval in order to determine a value corresponding to the event period.

Step 425, SYNTHESIZE GATE SIGNAL, may include synthesizing a gate signal to establish a sample rate based on the event period. For example, if a sample rate corresponding to 0.1 degrees of rotation by the wheel 38 is desired, the synthesizer 40 may synthesize a gate signal having a period one sixtieth ( 1/60) of the event period.

Step 430, DETERMINE FILTER COEFFICIENT, may include determining a filter coefficient based on the sample rate and the desired filter characteristic. For example, for a particular desired filter characteristic or desired transfer function, filter coefficients may be determined via a look up table, where the value selected from the look-up table is determined based on the speed (RPM) of the engine 24.

Step 435, SAMPLE ANALOG SIGNAL, may include sampling the analog signal 18 at the sample rate to generate the sampled signal 16.

Step 440, DIGITALLY FILTER SAMPLED SIGNAL, may include digital filtering the sampled signal 16 using the filter coefficient. By this method, the filter characteristic or transfer function may be unchanged or unaffected by changes in the filter sample rate caused by change in engine speed. The steps 435 and 440 may be repeated for a predetermined period of time, or a predetermined amount of engine rotation as indicated by wheel 38, or until a third engine event is detected.

Step 445, DETECT THIRD ENGINE EVENT, may include detecting a pulse in the engine event signal subsequent to detecting the second engine event.

Step 450, DETERMINE UPDATED EVENT PERIOD, may include determining an updated event period corresponding to an updated time interval between the second engine event and a third engine event indicated by the engine event signal.

Step 455, SYNTHESIZE GATE SIGNAL, may include synthesizing the gate signal to establish an updated sample rate based on the updated event period.

Step 460, DETERMINE UPDATED FILTER COEFFICIENT, may include determining an updated filter coefficient based on the updated sample rate and the desired filter characteristic.

Step 465, SAMPLE ANALOG SIGNAL, may include sampling the analog signal at the updated sample rate to generate the sampled signal.

Step 470, DIGITALLY FILTER SAMPLED SIGNAL, may include digital filtering the sampled signal using the updated filter coefficient.

Step 475, DETECT FORTH ENGINE EVENT, may include digital filtering the sampled signal using the updated filter coefficient continues until a forth engine event is detected.

Accordingly, engine control system 10, an event driven engine controller 12 for the engine control system 10 and a method 400 of implementing a digital filter 14 configured to sample an analog signal 18 at a sample rate dependent on a variable time interval between engine events is provided. This provides a way for the event driven engine controller 12 to enjoy the flexibility and consistency of the digital filter 14 even though the sample rate used to generate the sampled signal 18 sent to the digital filter 14 may vary, and so avoid the expense, complexity, and controller proliferation experienced by those making or using event driven engine controllers that rely on analog filters.

While this invention has been described in terms of the preferred embodiments thereof, it is not intended to be so limited, but rather only to the extent set forth in the claims that follow.

We claim:

1. A method of implementing a digital filter in an event driven engine controller configured to sample an analog signal at a sample rate dependent on a time interval between engine events, said method comprising the steps:
selecting a desired filter characteristic to filter a sampled signal arising from sampling the analog signal;
determining an event period corresponding to a time interval between a first engine event and a second engine event indicated by an engine event signal;
synthesizing a gate signal to establish a sample rate based on the event period;
determining a filter coefficient based on the sample rate and the desired filter characteristic;
sampling the analog signal at the sample rate to generate the sampled signal; and
digital filtering the sampled signal using the filter coefficient.

2. The method in accordance with claim 1, wherein the analog signal is indicative of an engine combustion process.

3. The method in accordance with claim 2, wherein the analog signal is output by one of an in-cylinder pressure sensor, an in-cylinder flame sensor, and a knock sensor.

4. The method in accordance with claim 1, wherein the sample rate is proportional the event period.

5. The method in accordance with claim 1, wherein the event signal is indicative of a crank position.

6. The method in accordance with claim 1, wherein the first engine event and the second engine event each correspond to a distinct crank position.

7. The method in accordance with claim 1, wherein digital filtering using the filter coefficient continues until a third engine event is detected, whereupon the method performs the steps
determining an updated event period corresponding to an updated time interval between the second engine event and a third engine event indicated by the engine event signal;
synthesizing the gate signal to establish an updated sample rate based on the updated event period;
determining an updated filter coefficient based on the updated sample rate and the desired filter characteristic;
sampling the analog signal at the updated sample rate to generate the sampled signal; and
digital filtering the sampled signal using the updated filter coefficient.

8. The method in accordance with claim 7, wherein the first engine event, the second engine event, and the third engine event each correspond to a distinct crank position.

9. The method in accordance with claim 7, wherein digital filtering the sampled signal using the updated filter coefficient continues until a forth engine event is detected.

10. An event driven engine controller comprising:
a processor configured to
store a desired filter characteristic to filter a sampled signal arising from sampling the analog signal;
determine an event period corresponding to a time interval between a first engine event and a second engine event indicated by an engine event signal;
synthesize a gate signal to establish a sample rate based on the event period;
determine a filter coefficient based on the sample rate and the desired filter characteristic;
sample the analog signal at the sample rate to generate the sampled signal; and
digitally filter the sampled signal using the filter coefficient.

11. The controller in accordance with claim 10, wherein the processor is further configured to continue to digitally filter using the filter coefficient until a third engine event is detected, and then
determine an updated event period corresponding to an updated time interval between the second engine event and a third engine event indicated by the engine event signal;
synthesize the gate signal to establish an updated sample rate based on the updated event period;
determine an updated filter coefficient based on the updated sample rate and the desired filter characteristic;
sample the analog signal at the updated sample rate to generate the sampled signal; and
digitally filter the sampled signal using the updated filter coefficient.
